(19) United States
(12) Patent Application Publication
(10) Pub. No.: US 2015/0179369 A1
(43) Pub. Date: Jun. 25, 2015

(54) BUTTON ASSEMBLEY OF ENGINE START/STOP SWITCH FOR VEHICLES AND ENGINE START/STOP SWITCH FOR VEHICLES INCLUDING THE SAME

(71) Applicant: ALPS ELECTRIC KOREA CO., LTD., Gwangju (KR)

(72) Inventors: Wonil CHOI, Gwangju (KR); Hyundu CHOI, Gwangju (KR); Kyoungsun YEOM, Gwangju (KR); Seoknam OH, Gwangju (KR)

(21) Appl. No.: 14/582,322

(22) Filed: Dec. 24, 2014

(30) Foreign Application Priority Data
Dec. 24, 2013 (KR) 20-2013-0010739

(51) Int. Cl. H01H 13/50; H01Q 7/00; H01H 1/58; H01Q 1/32

(52) U.S. Cl. CPC H01H 13/506; H01Q 1/3233; H01Q 7/00; H01H 1/5833; H01H 2231/026

(57) ABSTRACT

A button part of an engine start/stop switch for a vehicle includes a button of which an end portion is exposed to the outside to be pressed for start or stop of an engine; a slider which is arranged at the front end portion of the button to slide along the inner circumferential surface of a housing; and a coil antenna which is arranged outside the button and the slider to send driving radio waves to a transponder of a portable device that a driver carries.

### BACKGROUND OF THE INVENTION

1. Field of the Invention

The present invention relates to a button assembly of an engine start/stop switch for a vehicle and an engine start/stop switch for a vehicle including the same, and more particularly, to a button assembly of an engine start/stop switch for a vehicle and an engine start/stop switch for a vehicle including the button assembly each of which includes a coil antenna arranged adjacent to a button for generating an electromotive force to a portable device even when voltage of the portable device drops to ignite an ignition plug in order to send an ID code to an ECU of the vehicle, thereby reducing manufacturing costs and the manufacturing process because a portable device holder can be removed from the inside of the vehicle and allowing a driver to utilize a space where the portable device holder was removed in various ways.

2. Background Art

In general, a key for a vehicle includes just a key plate, and the keys have been developed into various kinds, namely, not only basic keys of a plate form that a driver has to directly insert the key into a key box to start the vehicle but also remote control keys which have a function to open and close a door and start a vehicle at a long range and smart keys which releases a door lock when the driver who has the smart key approaches the vehicle and allows the driver to start the vehicle in a push button type after getting in the vehicle.

Moreover, recently, a portable device which sends an ID code signal including an ID code with the purpose of preventing vehicle theft has been disclosed.

When the driver presses an ignition switch (button) in a state where the ID code of the portable device coincides with an ID code of an ECU of the vehicle on condition that the ID code signal coincides with the ID code previously set to the ECU of the vehicle, such a portable device automatically operates a start motor to start an engine of the vehicle.

After that, in case that the portable device cannot automatically send the ID code signal by voltage drop of a battery of the portable device, when the driver inserts the portable device into a portable device holder mounted inside the vehicle, a coil antenna (immobilizer coil) built in the portable device holder sends driving radio waves to a transponder mounted inside the portable device, such that an electromotive force which make the portable device send the ID code signal is generated to start the engine.

However, the conventional engine start/stop switch for the vehicle has several disadvantages in that it requires lots of manufacturing costs and many manufacturing processes because the portable device holder for mounting the coil antenna to send the driving radio waves to the portable device and generate the electromotive force must be formed inside the vehicle and in that it is difficult to secure a space for mounting other functional element due to the occupation space of the portable device holder.

### PRIOR ART DOCUMENTS

### Patent Documents

Patent Document 1: Korean Patent Publication No. 2010-0038616

### SUMMARY OF THE INVENTION

Accordingly, the present invention has been made to solve the above-mentioned problems occurring in the prior arts, and it is an object of the present invention to provide a button assembly of an engine start/stop switch for a vehicle and an engine start/stop switch for a vehicle including the button assembly each of which includes a coil antenna arranged adjacent to a button for generating an electromotive force to a portable device even when voltage of the portable device drops to ignite an ignition plug in order to send an ID code to an ECU of the vehicle, thereby reducing manufacturing costs and the manufacturing process because a portable device holder can be removed from the inside of the vehicle and allowing a driver to utilize a space where the portable device holder was removed in various ways.

It is another object of the present invention to provide a button assembly of an engine start/stop switch for a vehicle and an engine start/stop switch for a vehicle including the button assembly in which the coil antenna is arranged outside the button and a slider in order to effectively transfer driving radio waves.

To accomplish the above object, according to the present invention, there is provided a button part of an engine start/stop switch for a vehicle including: a button of which an end portion is exposed to the outside to be pressed for start or stop of an engine; a slider which is arranged at the front end portion of the button to slide along the inner circumferential surface of a housing; and a coil antenna which is arranged outside the button and the slider to send driving radio waves to a transponder of a portable device that a driver carries.

Moreover, the button, the slider and the coil antenna are formed integrally.

In another aspect of the present invention, there is provided an engine start/stop switch for a vehicle including: a button part including a button of which an end portion is exposed to the outside to be pressed for start or stop of an engine, a slider which is arranged at the front end portion of the button to slide along the inner circumferential surface of a housing, and a coil antenna which is arranged outside the button and the slider to send driving radio waves to a transponder of a portable device that a driver carries; a circuit part which gets in contact with the front end portion of the slider and has a PCB and an elastic plate, the elastic plate being arranged on the upper side of the PCB and having a contact point protrusion which is in a contact point with the PCB while being elastically pressurized and released from pressurization whenever the slider presses so as to operate an engine start/stop signal; and the housing which surrounds the button part and the circuit part.

Furthermore, the engine start/stop switch further includes a support cover which located at the lower end of the housing and is inserted and joined into the inner circumferential surface of the housing.

Additionally, the engine start/stop switch further includes: an upper cover which is located at the upper end of the housing to cover the housing; and a protective ring which is joined to a side of the upper end of the housing.

In addition, the engine start/stop switch further includes a connection part for connecting the coil antenna and the circuit part with each other. Furthermore, the button, the slider and the coil antenna of the button part are formed integrally.

As described above, the engine start/stop switch for the vehicle including the button assembly according to an embodiment of the present invention includes the coil antenna arranged adjacent to the button for generating an electromotive force to the portable device even when voltage of the portable device drops to ignite the ignition plug in order to send the ID code to the ECU of the vehicle, thereby reducing manufacturing costs and the manufacturing process because a portable device holder can be removed from the inside of the vehicle and allowing the driver to utilize a space where the portable device holder was removed in various ways.

Additionally, the button assembly of the engine start/stop switch for the vehicle and the engine start/stop switch for the vehicle including the button assembly effectively transfer driving radio waves because the coil antenna is arranged outside the button and a slider.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a button part of an engine start/stop switch for a vehicle according to a preferred embodiment of the present invention;

FIG. 2 is an exploded perspective view of the button part of the engine start/stop switch for the vehicle;

FIG. 3 is an exploded perspective view of an engine start/stop switch for a vehicle according to a preferred embodiment of the present invention; and

FIG. 4 is a sectional view of the engine start/stop switch for the vehicle.

### DETAILED DESCRIPTION OF THE PREFERRED EMBODIMENT

Reference will be now made in detail to the preferred embodiments of the present invention with reference to the attached drawings.

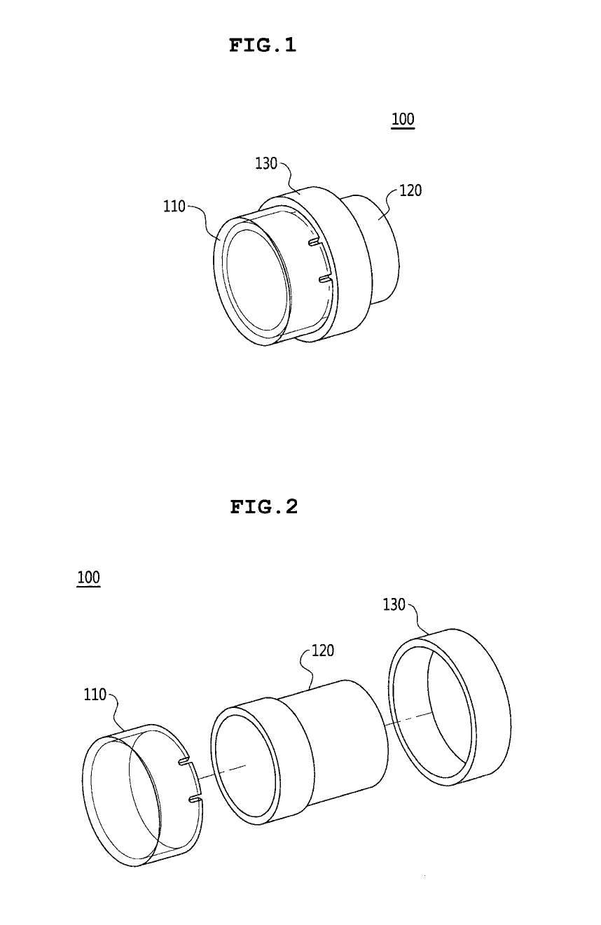

FIG. 1 is a perspective view showing a button part of an engine start/stop switch for a vehicle according to a preferred embodiment of the present invention, and FIG. 2 is an exploded perspective view of the button part of the engine start/stop switch for the vehicle.

Referring to FIGS. 1 and 2, the button part of the engine start/stop switch for the vehicle in an aspect of the present invention includes: a button 110 of which an end portion is exposed to the outside to be pressed for start or stop of an engine; a slider 120 which is arranged at the front end portion of the button 110 to slide along the inner circumferential surface of a housing 200; and a coil antenna 130 which is arranged outside the button 110 and the slider 120 to send driving radio waves to a transponder of a portable device that a driver carries.

The button 110 has a circular pipe structure and includes a pressing part which is disposed at an end portion thereof and is sealed for pressurization. The coil antenna 130 is mounted at the other end of the button 110 and located outside the button 110 and the slider 120 to cover the outer circumferential surface of the slider 120. In this instance, the button 110, the slider 120 and the coil antenna 130 have an integrated structure that they are assembled detachably.

Therefore, when the driver presses the button 110, the button 110, all of the slider 120 and the coil antenna 130 are operated in an all-in-one type. Moreover, because the coil antenna 130 is arranged at the outermost side, the engine start/stop switch for the vehicle according to the preferred embodiment of the present invention can transfer driving radio waves to the transponder of the portable device through the coil antenna 130 without any restriction of other components of the button part 100.

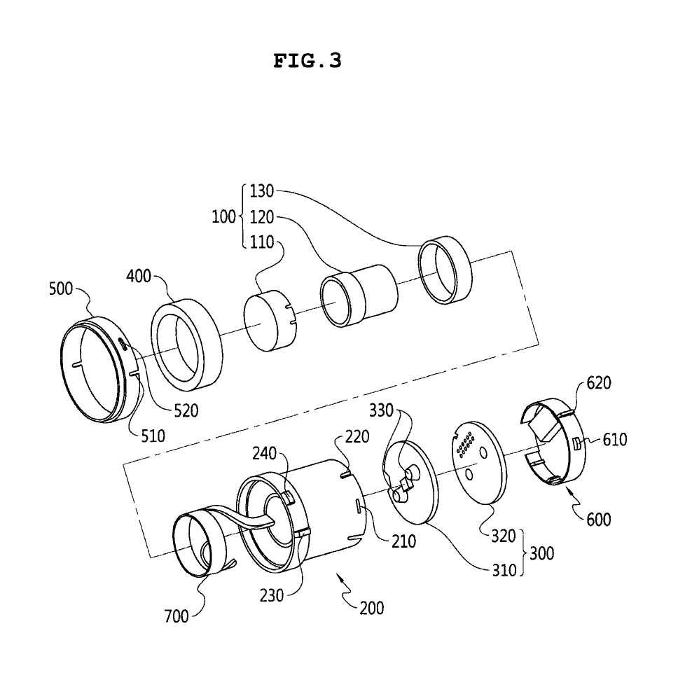

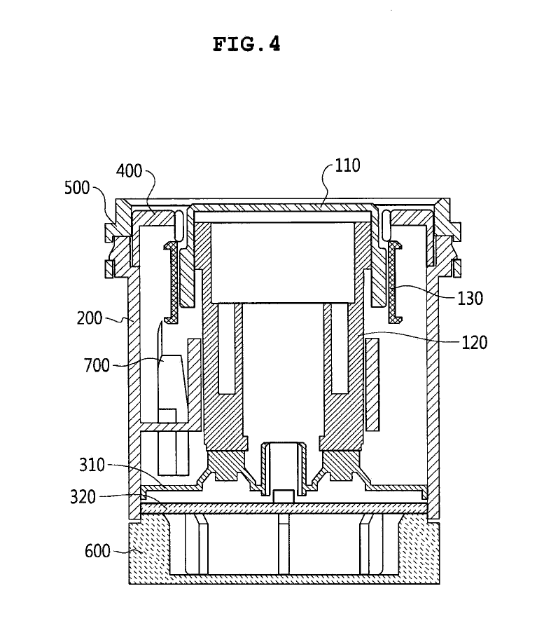

FIG. 3 is an exploded perspective view of an engine start/stop switch for the vehicle according to a preferred embodiment of the present invention, and FIG. 4 is a sectional view of the engine start/stop switch for the vehicle.

Referring to FIGS. 3 and 4, the engine start/stop switch for the vehicle according to a preferred embodiment of the present invention includes: a button part 100 including a button 110 of which an end portion is exposed to the outside to be pressed for start or stop of an engine, a slider 120 which is arranged at the front end portion of the button 110 to slide along the inner circumferential surface of a housing 200, and a coil antenna 130 which is arranged outside the button 110 and the slider 120 to send driving radio waves to a transponder of a portable device that a driver carries; a circuit part 300 which gets in contact with the front end portion of the slider 120 and has a PCB 320 and an elastic plate 310, the elastic plate 310 being arranged on the upper side of the PCB 320 and having a contact point protrusion 330 which is in a contact point with the PCB 320 while being elastically pressurized and released from pressurization whenever the slider 120 presses so as to operate an engine start/stop signal; and the housing 200 which surrounds the button part 100 and the circuit part.

As described above, the button part 100 is characterized by the circuit part 300 including: the PCT 320 of a plate type; and the elastic plate 310 which is made of a rubber material and has the contact point protrusion 330 which is in a contact point with the PCB 320 while being elastically pressurized and released from pressurization whenever the button 110 is pressed so as to operate the engine start/stop signal.

That is, after the button 110 is pressed and the PCB 320 is in contact point, the pressing force is removed, the button 110 is returned to its original state by an elastic force of the elastic plate 310.

The housing 200 has the structure to cover the button part 100 and the circuit part 300 and has a protective ring joining protrusion which is formed at the upper end portion to be joined with a protective ring 500. The protective ring joining protrusion includes a protective ring sliding protrusion 230 and a protective ring joining protrusion 240 which are respectively inserted and caught into a protective ring sliding groove 510 and a protective ring joining slot 520 formed in the protective ring 500.

Furthermore, the housing 200 includes a support cover joining slot 210 and a support cover sliding groove 220 which are formed at the lower end portion thereof and to which a support cover joining protrusion 610 and a support cover sliding protrusion 620 of a support cover 600 are respectively joined, such that the housing 200 is joined with the support cover 600.

Additionally, inside the housing 200, disposed is a connection part 700 which connects the coil antenna 130 and the circuit part 300 with each other to transfer input and output signal information of the PCB 320 to a circuit terminal of the PCB 320.

The connection part 700 which is in a cylindrical shape is connected with the coil antenna 130, and is connected with the circuit part 300 through a structure that the cylindrical shape of the connection part 700 is changed into a wire shape. Through the arrangement of the connection part 700, for instance, light of an LED (not shown) of the PCB 320 can clearly reach as far as the button 110 without any interference of the connection part 700.

An upper cover 400 covers an exposed upper end portion of the housing 200 to protect the upper end portion of the housing 200, and the protective ring 500 is joined around the upper cover 400.

Now, an assembling process of the engine start/stop switch for the vehicle according to the preferred embodiment of the present invention will be described. First, after the slider 120 is covered by the button 110, the coil antenna 130 is joined to the outside of the slider 120.

Next, the circuit part 30 is closely arranged at the lower end portion of the slider 120 in order to connect the PCB 320 and the coil antenna 130 with each other through the connection part 700, and then, the housing 200 is covered. After that, the support cover 600 is joined to the lower end of the housing 200 to support the circuit part 300.

Moreover, the upper cover 400 covers the upper end of the housing 200 and the protective ring 500 is joined to the rim of the housing 200. Then, the engine start/stop switch is finally assembled.

In the above state, when a user which carries a portable device gets on the vehicle, an ID code signal of the portable device is automatically transferred to an ECU of the vehicle. The ECU judges whether or not the received ID code of the portable device coincides with an ID code which is previously set. When the user presses the button 110 in a state where the ID codes coincide with each other, a smart motor is operated to start the engine of the vehicle.

After that, in case that the ID code signal is not automatically transferred due to voltage drop of a battery of the portable device, when the user presses the button 110, for instance, with the hand while grasping the portable device in his or her hand, near the button 110 (in a range of about 50 mm, the coil antenna 130 (immobilizer coil) at the side of the button 110 sends driving radio waves to the transponder of the portable device to generate an electromotive force which makes the portable device send the ID code signal again, such that the engine of the vehicle can be started.

While the present invention has been described with reference to the particular illustrative embodiment, it will be understood by those skilled in the art that various embodiments simply combined with the prior arts and various changes and modifications which can be made by those skilled in the art using the claims and the specification of the present invention belong to the technical scope of the present invention.

What is claimed is:

1. A button part of an engine start/stop switch for a vehicle, comprising:
a button (110) of which an end portion is exposed to the outside to be pressed for start or stop of an engine;
a slider (120) which is arranged at the front end portion of the button (110) to slide along the inner circumferential surface of a housing (200); and
a coil antenna (130) which is arranged outside the button (110) and the slider (120) to send driving radio waves to a transponder of a portable device that a driver carries.

2. The button part of the engine start/stop switch according to claim 1, wherein the button (110), the slider (120) and the coil antenna (130) are formed integrally.

3. An engine start/stop switch for a vehicle, comprising:
a button part (100) including a button (110) of which an end portion is exposed to the outside to be pressed for start or stop of an engine, a slider (120) which is arranged at the front end portion of the button (110) to slide along the inner circumferential surface of a housing (200), and a coil antenna (130) which is arranged outside the button (110) and the slider (120) to send driving radio waves to a transponder of a portable device that a driver carries;
a circuit part (300) which gets in contact with the front end portion of the slider (120) and has a PCB (320) and an elastic plate (310), the elastic plate (310) being arranged on the upper side of the PCB (320) and having a contact point protrusion (330) which is in a contact point with the PCB (320) while being elastically pressurized and released from pressurization whenever the slider (120) presses so as to operate an engine start/stop signal; and
the housing (200) which surrounds the button part (100) and the circuit part.

4. The engine start/stop switch according to claim 3, further comprising:
a support cover (600) which located at the lower end of the housing (200) and is inserted and joined into the inner circumferential surface of the housing (200).

5. The engine start/stop switch according to claim 3, further comprising:
an upper cover (400) which is located at the upper end of the housing (200) to cover the housing (200); and
a protective ring (500) which is joined to a side of the upper end of the housing (200).

6. The engine start/stop switch according to claim 3, further comprising:
a connection part (700) for connecting the coil antenna (130) and the circuit part (300) with each other.

7. The engine start/stop switch according to claim 3, wherein the button (110), the slider (120) and the coil antenna (130) of the button part (100) are formed integrally.
